(19) United States
(12) Patent Application Publication
(10) Pub. No.: US 2013/0100588 A1
(43) Pub. Date: Apr. 25, 2013

(54) COMPUTER WITH FAN SPEED CONTROL SYSTEM FOR SYNCHRONIZING SPEEDS OF SYSTEM FAN AND POWER FAN

(71) Applicant: YAO-TING CHANG, Tu-Cheng (TW)

(72) Inventor: YAO-TING CHANG, Tu-Cheng (TW)

(73) Assignee: HON HAI PRECISION INDUSTRY CO., LTD., Tu-Cheng (TW)

(21) Appl. No.: 13/311,564

(22) Filed: Dec. 6, 2011

(30) Foreign Application Priority Data
Oct. 21, 2011 (TW) 100138189

(51) Int. Cl. G06F 1/20; H02B 1/015

(52) U.S. Cl. 361/627; 361/679.48

(57) ABSTRACT

A computer includes a power supply for providing electrical power, a system fan, a power fan for cooling the power supply, and a fan speed control system. The fan speed control system is configured to synchronize a rotation speed of the system fan and the power fan.

### BACKGROUND

1. Technical Field

The present disclosure relates to a computer having a fan speed control system for synchronizing speeds of a system fan and a power fan.

2. Description of Related Art

Desktop computers typically include a system fan to cool the interior of the computer chassis and a power fan to cool the power supply. The rotation speed of the system fan changes according to the ambient temperature, and the rotation speed of the power fan changes according to the load of the power supply. When the ambient temperature is high and the load of the power supply is low, the system fan rotates faster than the power fan. The system fan can then blow heated air onto the power supply. However, the power fan at lower speeds cannot dissipate the heated air in a timely manner, causing the heated air to flow back to the computer chassis. That will lead to ineffectiveness in the heat dissipation of the desktop computer.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a computer according to an exemplary embodiment.

FIG. 2 is a block diagram view of the computer of FIG. 1.

### DETAILED DESCRIPTION

Embodiments of the present disclosure are now described in detail, with reference to the accompanying drawings.

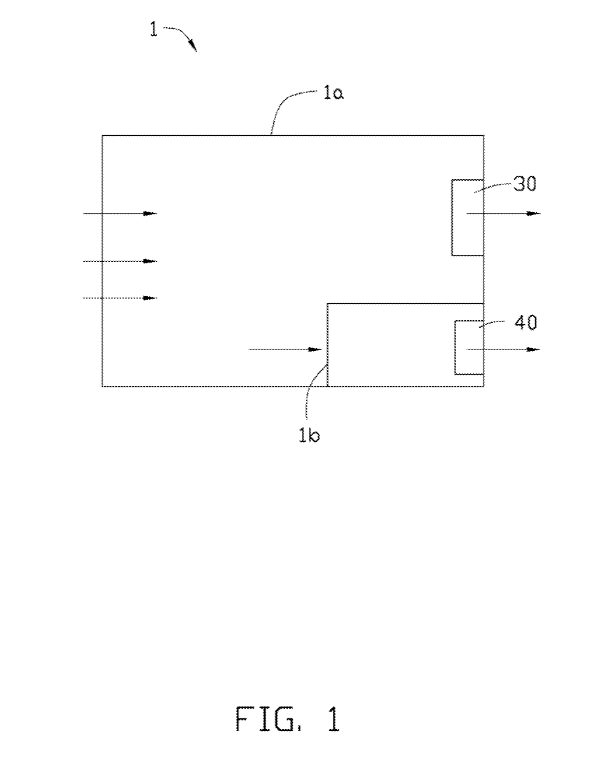

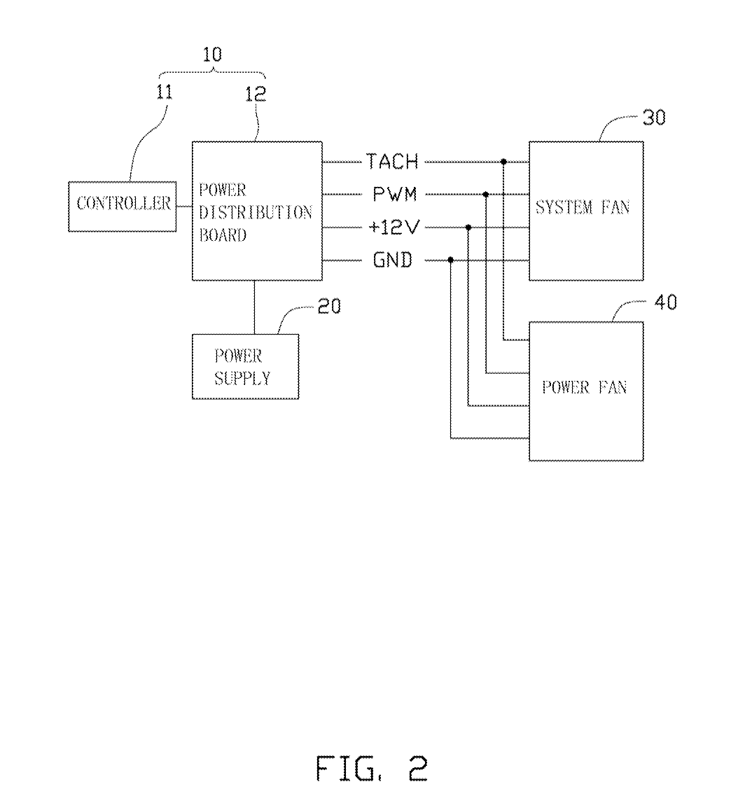

Referring to FIGS. 1 and 2, a computer 1 according to an exemplary embodiment is illustrated. The computer 1 includes a computer chassis 1a and a power supply chassis 1b retained within the computer chassis 1a for providing electrical power. The computer 1 includes a fan speed control system 10, a power supply 20 retained within the power supply chassis 1b, a system fan 30 retained within the computer chassis 1a for cooling the interior of the computer chassis 1a, and a power fan 40 retained within the power supply chassis 1b for cooling the power supply 20.

The fan speed control system 10 includes a controller 11 and a power distribution board 12. The controller 11, the power supply 20, the system fan 30, and the power fan 40 are all connected to the power distribution board 12. The controller 11 controls the power distribution board 12 to distribute power to the system fan 30 and the power fan 40. The controller 11 may be a basic input output system (BIOS) or a baseboard management controller (BMC) unit that stores a predefined program for controlling the rotation speeds of the system fan 30 and the power fan 40. In the embodiment, the controller 11 can adjust the rotation speeds of the system fan 30 and the power fan 40 according to the ambient temperature of the computer 1.

The system fan 30 and the power fan 40 are respectively connected to the power distribution board 12 via a TACH cable and a PWM (pulse width modulation) cable. The power distribution board 12 modulates the commands of the controller 11 into PWM signal for controlling the rotation speeds of the system fan 30 and the power fan 40. The TACH cable transmits in real-time the rotation speeds of the system fan 30 and the power fan 40 back to the controller 11.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A computer comprising:
a power supply for providing electrical power;
a power fan for cooling the power supply;
a system fan; and
a fan speed control system configured to synchronize speeds of the system fan and the power fan.

2. The computer as described in claim 1, wherein the fan speed control system comprises a controller and a power distribution board, and the power supply, the system fan, and the power fan are all connected to the power distribution board.

3. The computer as described in claim 1, wherein the system fan and the power fan are connected to the power distribution board via a TACH cable and a PWM cable.

4. The computer as described in claim 1, wherein the controller is a basic input output system or a baseboard management controller that stores a predefined program for controlling the rotation speeds of the system fan and the power fan.

5. The computer as described in claim 1, wherein the controller adjusts the rotation speeds of the system fan and the power fan according to an ambient temperature of the computer.
